(19) United States
(12) Patent Application Publication
(10) Pub. No.: US 2012/0095785 A1
(43) Pub. Date: Apr. 19, 2012

(54) METHOD OF MANAGING AN INSURANCE SCHEME AND ASYSTEM THEREFOR

(75) Inventors: Adrian Gore, Sandton (ZA); Barry Swartzberg, Sandton (ZA)

(73) Assignee: DISCOVERY HOLDINGS LIMITED, Sandton (ZA)

(21) Appl. No.: 13/318,620

(22) PCT Filed: Apr. 15, 2011
(86) PCT No.: PCT/IB11/51644

§ 371 Date: Dec. 27, 2011

(30) Foreign Application Priority Data
Apr. 15, 2010 (ZA) 2010/02640

(51) Int. Cl. G06Q 40/08

(52) U.S. Cl. 705/4

(57) ABSTRACT

A method and system for managing an insurance scheme includes receiving claim data from an insured person, the claim data including information pertaining to the occurrence of an insured event and the amount of a claim to an insurer. The claim data is analysed to determine a total amount payable to the insured person. An amount to be paid to the insured person from a life insurance fund of the insured person is calculated and an amount to be paid to the insured person from the insurer is calculated wherein the amount paid from the life fund and the amount paid from the insurer equal the total amount payable.

### BACKGROUND OF THE INVENTION

The present invention relates to a method of managing an insurance scheme and a system therefor.

Various insurance schemes exist to insure household contents or motor vehicles, for example in the event of an accident or against theft.

These insurance schemes typically operate by the insured person paying a premium to the insurer and on the occasion of an insured event, the insurer pays an amount out to the insured person.

There is also typically an excess amount payable by the insured person in the event of a claim. This excess amount is a first amount payable by the insured person in the event of a claim.

The present invention seeks to provide an improved method and system.

### SUMMARY

According to one example embodiment there is provided a method of managing an insurance scheme, the method including:
receiving claim data from an insured person, the claim data including information pertaining to the occurrence of an insured event and the amount of a claim to an insurer;
analysing the claim data to determine a total amount payable to the insured person;
calculating an amount to be paid to the insured person from a life insurance fund of the insured person; and
calculating an amount to be paid to the insured person from the insurer wherein the amount paid from the life fund and the amount paid from the insurer equal the total amount payable.

The method further includes calculating an excess amount payable by the insured person wherein the total amount payable equals the sum of the excess amount, the amount paid from the life fund and the amount paid from the insurer.

Furthermore, the method includes reducing the life fund by the amount to be paid from the life fund to the insured person.

The method may further include:
receiving data relating to a life insurance premium amount received from the insured person and storing this in a database;
receiving data relating to another insurance premium amount received from the insured person and storing this in a database;
receiving a request from the insured person to link their life insurance fund to their other insurance; and
calculating a revised life insurance premium amount which is higher than the previously stored life insurance premium amount and a revised other insurance premium amount which is lower than the previously stored insurance premium amount wherein the combined revised premium amounts are lower than the combined stored premium amounts.

According to another example embodiment there is provided a system for managing an insurance scheme, the system including:
a receiving module for receiving claim data from an insured person, the claim data including information pertaining to the occurrence of an insured event and the amount of a claim to an insurer;
an analysing module for analysing the claim data to determine a total amount payable to the insured person;
a calculation module for calculating an amount to be paid to the insured person from a life insurance fund of the insured person and calculating an amount to be paid to the insured person from the insurer wherein the amount paid from the life fund and the amount paid from the insurer equal the total amount payable.

The calculation module in one example calculates an excess amount payable by the insured person wherein the total amount payable equals the sum of the excess amount, the amount paid from the life fund and the amount paid from the insurer.

In one embodiment, the calculation module reduces the life fund by the amount to be paid from the life fund to the insured person.

The system may further include:
the receiving module receives data relating to a life insurance premium amount received from the insured person and stores this in the database, the receiving module also receives data relating to another insurance premium amount received from the insured person and stores this in the database;
the receiving module further receives a request from the insured person to link their life insurance fund to their other insurance; and
the calculation module calculates a revised life insurance premium amount which is higher than the previously stored life insurance premium amount and a revised other insurance premium amount which is lower than the previously stored insurance premium amount wherein the combined revised premium amounts are lower than the combined stored premium amounts.

### BRIEF DESCRIPTION OF THE DRAWINGS

FIG. 1 is a block diagram illustrating an example system to implement the methodologies described herein; and

FIG. 2 is a block diagram illustrating an example embodiment method.

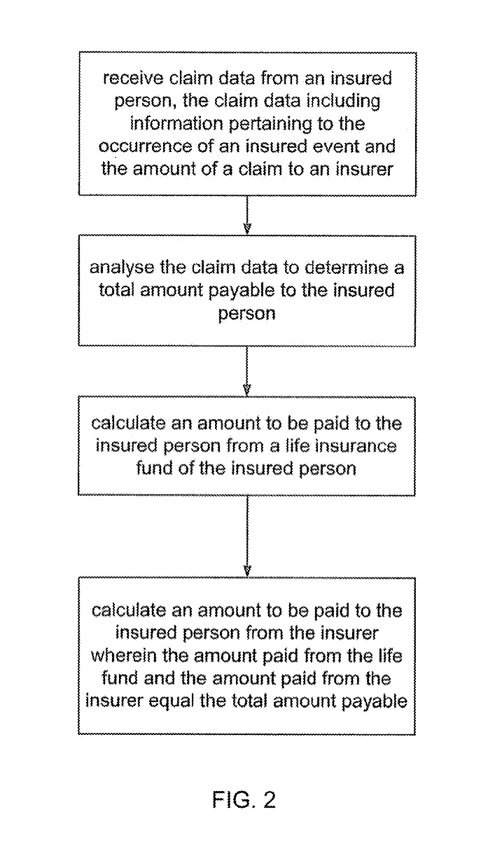

### DESCRIPTION OF EMBODIMENTS

The present invention relates to a method of managing an insurance scheme and a system therefor, particularly a so-called short term insurance.

A short term insurance scheme usually cover things like household contents, valuables that a person carries with them, motor vehicles and other such things.

Thus the short term insurance typically covers a cost incurred by the insured person or replaces a lost or destroyed object of the insured person.

It will be appreciated that short term insurance could conceptually be used by an insured person to insure against an insured event being any kind of loss.

The term short term insurance is of common use in South Africa whereas in other countries, particularly in the USA, the term property and casualty is used to describe this kind of insurance. Although for purposes of this description the term short term insurance will be used, it will be appreciated that this also refers to property and casualty insurance.

In any event, a premium is paid from the insured person to the short term insurer in return for which the selected insurance is activated. On the occurrence of an insured event, the insurer pays the insured person an amount.

As an example, if an insured person insures their motor vehicle, they pay the insurer a premium (such as a monthly premium, for example) and on the occurrence of an insured event such as a motor vehicle accident the insurer pays the insured person an amount to have the vehicle fixed. In some instances this amount is paid directly to a panel beater on behalf of the insured person.

In another illustrative example, the insured person obtains insurance for loss of household contents due to theft, fire, flooding or any other event, for example. So in the case of theft, for example, the insured person will claim an amount from the insurer to be paid out to the insured person.

It will be appreciated that short term insurance could be applied to any article or event and is not limited to the above examples.

Another type of insurance product which is common is life insurance whereby an insured person pays a premium to a life insurer and on the event of the person dying the insurer pays an amount to a nominated beneficiary of the insured person.

It will be appreciated that this type of life insurance often includes insurance for disability and/or dread disease so that the insured person is paid out on the occurrence of these if they are defined as insurable under the particular life policy that the insured person has with the insurer.

In the South African context this type of insurance is referred to as life insurance or long term insurance whilst in other countries this type of insurance is referred to simply as life insurance.

In any event, the amount to be paid out to the insured person on the occurrence of an insured event may be paid out in installments or in a lump sum. In either case the total amount which will be paid out by the life insurer will be referred to herein after as the life fund.

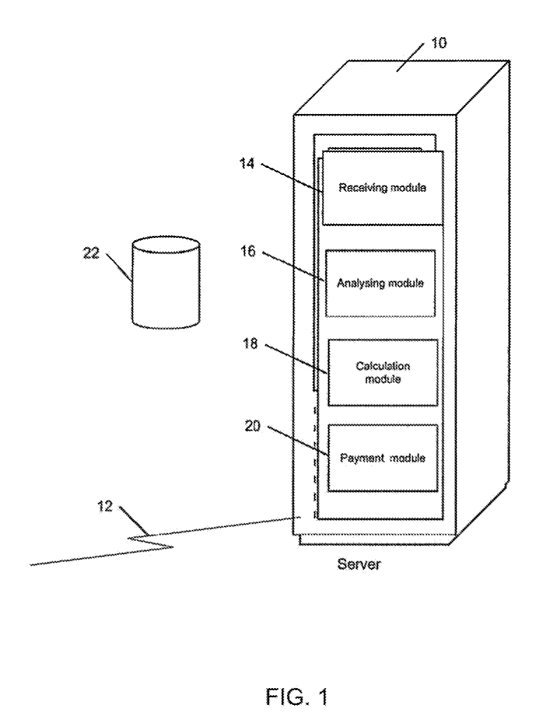

Referring to the accompanying Figures, a system to implement the present invention and the methodologies described below in one example embodiment includes a server 10 as shown in FIG. 1 together with a number of modules which are described below in more detail. These modules described below may be implemented by a machine-readable medium embodying instructions which, when executed by a machine, cause the machine to perform any of the methods described herein.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein. The claim data is received from an insured person either directly or through an intermediary.

In either case, the claim data includes information pertaining to the occurrence of an insured event and the amount of a claim to the insurer.

The claim data is analysed by an analysing module 16 to determine a total amount payable to the insured person.

The total amount payable will depend on such issues as the amount of the loss and on the amount of insurance obtained by the insured person.

For example, if the claim is for a broken camera and the camera is worth R10,000 and is fully insured then the total amount of the claim to the insurer will be R10,000. If the claim is assessed and all is in order meaning that there are no irregularities with the claim and all of the insurance conditions have been complied with then the total amount payable by the insurer to the insured person will be R10,000.

A calculating module 18 then calculates an amount to be paid to the insured person from a life insurance fund of the insured person.

In this example, the insured person is accelerating a payout from their life insurance fund as a payout on a short term insurance claim.

In one example embodiment this is selected upfront by the insured person whilst in another embodiment this is selected by the insured person on a claim by claim basis.

So in the above example, if the insured person selects an amount of R5,000 to be paid from their life insurance fund then the calculating module 18 uses this information to calculate an amount to be paid to the insured person wherein the amount paid from the life fund and the amount paid from the insurer equal the total amount payable.

In this illustrative example, the amount paid from the life fund will be R5,000 and the amount paid from the insurer will be R5,000 giving a total payment of R10,000.

Where an excess is payable by the insured person, the calculating module 18 further calculates an excess amount payable by the insured person wherein the total amount payable equals the sum of the excess amount, the amount paid from the life fund and the amount paid from the insurer.

For example, if the excess amount is R2,000, the total amount payable will be made up of R5,000 from the life fund, R2,000 excess self funded by the insured person and a R3,000 payment from the short term insurer.

Once a payment is made from the life fund, the amount of the life fund is reduced by the amount to be paid from the life fund to the insured person. Thus the amount of life insurance that the insured person has will have effectively been reduced by this payout.

In a second example embodiment, the insured person selects a standard excess on their short-term policy and selects, upfront, the amount of any short-term loss above the excess that will be accelerated from their life fund.

If the insured person chooses to accelerate R40,000 from their life fund and they have selected an excess of R3,000 then the amount payable by the short term insurer on a R100,000 claim will be R100,000−R3,000−R40,000=R57,000. Thus the short term insurer has an exposure of R57,000 rather than R97,000.

Finally, a payment module 20 effects the payout to the insured person or to a third party on behalf of the third person. This will typically be done by transmitting the required data across the communications network 12 to a financial institution such as a bank to make the payment.

It will be appreciated that in implementing the methodology, a high excess is typically selected by the insured person to allow a significant upfront discount on their short-term insurance. This is because insurance policies typically work by giving the insured person a lower premium for a larger excess amount as the larger the excess the less the risk to be carried by the insurer.

A further discount is offered to the insured person based on the following two main factors:
i. the reduction in eventual life claim amount payable (i.e. excess payment accelerates Life fund and so less is paid on death, disability and severe illness benefit).
ii. the excess in one year is funded through a long-term increasing premium structure (i.e. though the annual contribution increases).

In order to show how big the upfront discount is when compared to a short-term policy with, for example a R3,000 excess, one needs to view the short-term policy premium together with an additional premium on the life policy of the insured person to fund this and compare this to a typical premium for a R3 000 excess from a current standard insurer. An example of this is as follows:

| | Life | Monthly | Monthly | |
|---|---|---|---|---|
| Short | Fund | short term | Life | |
| Term | Accel- | insurance | additional | |
| Excess | erated | accident risk | benefit | Total |
| Level | Level | premium | premium | Premium |
| R 3,000 | R 0 | R 342 | R 0 | R 342 |
| R 60,000 | R 57,000 | R 36 | R 187 | R 223 |

| | |
|---|---|
| Upfront Discount | 35% |

In the above example, a short term insurance of a car valued at R160,000 carries an excess of R3,000 and a monthly premium of R342. If the car was stolen, for example, the short term insurer would pay out R157,000 to the car owner.

In terms of the present invention, the insured person would use their life fund to fund R57,000 of a claim on the short term insurance policy and so their short term insurance policy monthly premium would be decreased to R36 a month and their life insurance policy for R57,000 would be R187.

In the event of the car being stolen the short term insurer would pay R100,000, the insured person would fund the excess of R3,000 and an amount of R57,000 would be funded (accelerated) from their life insurance.

The amount of their life insurance would then be reduced by R57,000 even though they would be liable to continue pay their premium on the life insurance policy for the period of the policy to recover the accelerated withdrawn value, for example until they were 65 years of age.

Thus it will be appreciated that the insured person enjoys a significant discount on their monthly premium by following this route whilst the insurer is able to recoup any possible losses over a longer period.

In order to implement this, the server 10 typically receives data relating to a life insurance premium amount received from the insured person and stores this in the database 22.

The server 10 also receiving data relating to another insurance premium amount received from the insured person and stores this in the database 22.

Upon receiving a request from the insured person via the receiving module 14 to link their life insurance fund to their other insurance as described above, the calculation module 18 calculates a revised life insurance premium amount which is higher than the previously stored life insurance premium amount and a revised other insurance premium amount which is lower than the previously stored insurance premium amount wherein the combined revised premium amounts are lower than the combined stored premium amounts.

Thus it will be appreciated that the present invention provides the following advantages and benefits:
reduced short-term insurance premiums.
unlocks the value of the life insurance fund prior death or disability.
uses the financial asset of the life insurance policy to create immediate value for the short-term insurance product.

Thus it will be appreciated that a short-term and long-term insurance product are linked to reduce the financial burden to their policyholders.

1-8. (canceled)

9. A method of managing an insurance plan using at least one computer server, comprising:
receiving claim data into the at least one server relating to an insured person, the claim data including information pertaining to the occurrence of an insured event and the amount of a claim to an insurer;
analyzing the claim data, using the at least one server, to determine a total amount payable to the insured person;
calculating, using the at least one server, an amount to be paid to the insured person from a life insurance fund of the insured person; and
calculating, using the at least one server, an amount to be paid to the insured person from the insurer wherein the amount paid from the life fund and the amount paid from the insurer equal the total amount payable.

10. The method of claim 9 further including calculating, using the at least one server, a deductible amount payable by the insured person wherein the total amount payable equals the sum of the deductible amount, the amount paid from the life fund and the amount paid from the insurer.

11. The method of claim 9, wherein the method includes using the at least one server to calculate a reduction of the life fund by the amount to be paid from the life fund to the insured person.

12. The method of claim 9, further including:
receiving data relating to a life insurance premium amount received from the insured person and storing this in a database connectable to the at least one server;
receiving data relating to another insurance premium amount received from the insured person and storing this in a database connectable to the at least one server;
receiving a request from the insured person, into the at least one server, to link their life insurance fund to their other insurance; and
calculating, using the at least one server, a revised life insurance premium amount which is higher than the previously stored life insurance premium amount and a revised other insurance premium amount which is lower than the previously stored insurance premium amount wherein the combined revised premium amounts are lower than the combined stored premium amounts.

13. A system including at least one computer server for managing an insurance plan, the system comprising:
executing, by the at least one computer server, machine readable instructions stored on non-transitory media, the instructions including
(a) a receiving module for receiving claim data from an insured person into the at least one server, the claim data including information pertaining to the occurrence of an insured event and the amount of a claim to an insurer,
(b) an analysing module for analysing the claim data to determine a total amount payable to the insured person, and
(c) a calculation module for calculating an amount to be paid to the insured person from a life insurance fund of the insured person and calculating an amount to be paid to the insured person from the insurer wherein the amount paid from the life fund and the amount paid from the insurer equal the total amount payable.

14. The system of claim 13, further wherein the calculation module calculates an excess amount payable by the insured person wherein the total amount payable equals the sum of the excess amount, the amount paid from the life fund and the amount paid from the insurer.

15. The system of claim 13, wherein the calculation module reduces the life fund by the amount to be paid from the life fund to the insured person.

16. The system of claim 13, wherein:
the receiving module receives data relating to a life insurance premium amount received from the insured person and stores this in the database, the receiving module also receives data relating to another insurance premium amount received from the insured person and stores this in the database;
the receiving module further receives a request of the insured person to link their life insurance fund to their other insurance; and
the calculation module calculates a revised life insurance premium amount which is higher than the previously stored life insurance premium amount and a revised other insurance premium amount which is lower than the previously stored insurance premium amount wherein the combined revised premium amounts are lower than the combined stored premium amounts.
